(19) United States
(12) Patent Application Publication
(10) Pub. No.: US 2010/0081428 A1
(43) Pub. Date: Apr. 1, 2010

(54) Wireless Device Having Multiple Network Interfaces And Network Handover Capability

(76) Inventors: Harunobu Maejima, San Mateo, CA (US); Vijay Sundar Rajaram, Mountain View, CA (US); Zhiqiang Yang, Fremont, CA (US); Hitoshi Takanashi, San Mateo, CA (US)

Correspondence Address: TROP, PRUNER & HU, P.C., 1616 S. VOSS ROAD, SUITE 750, HOUSTON, TX, 77057-2631, US

(21) Appl. No.: 12/238,611

(22) Filed: Sep. 26, 2008

(51) Int. Cl. H04W 4/00; H04W 36/00; H04M 1/00

(52) U.S. Cl. 455/426.1; 455/436; 455/561

(57) ABSTRACT

A technique to transfer a first telephony session between a first telephony device and a second telephony device from being conducted through a first network interface of the first telephony device to being conducted through a second network interface of the first telephony device includes the following. A second telephony session between the first network interface and the second network interface is initiated, and subsequently a media termination point of the first telephony session is changed from the first network interface to the second network interface. The technique further includes changing a media termination point of the second telephony session from the first network interface to a location associated with the second telephony device.

### BACKGROUND

The invention generally relates to a wireless device that has multiple network interfaces and network handover capability.

An increasing number of wireless devices (personal digital assistants (PDAs), mobile telephones, etc.) have voice over Internet Protocol (herein called “VoIP”) capability, as VoIP is increasingly popular due to its low cost as compared to cellular communication. The VoIP technology typically makes use of cellular and Internet Protocol (IP) interfaces on modern wireless devices. A typical modern wireless device may therefore have an installed software-based VoIP phone or an embedded VoIP feature.

Because the modern wireless device may have multiple network interfaces, the device may be capable of communicating over a number of different cellular networks as well as capable of communicating over an IP network using one of a number of short range wireless networks (a WiFi or a WiMax network, as examples). Therefore, the wireless device may either connect through the cellular network or through a short range wireless network for a particular VoIP call.

During a VoIP call, the wireless device may need to transition from a short range wireless-based connection to a cellular-based connection, or vice versa. For example, a wireless device may initially connect through a WiFi access point for a VoIP call. Because the range of the short range wireless network is limited, it is possible that a user of the wireless device may travel to a location that is outside of the range of the short range wireless network during the VoIP call. Therefore, before communication is lost, a handover to a cellular network must occur. A seamless handover between multiple networks is often challenging to realize. One solution is the use of Unlicensed Mobile Access (UMA), in which the wireless device contacts a UMA network controller over an IP network to be authenticated and authorized to access Global System for Mobile communications (GSM) voice and General Packet Radio Services (GPRS) data services via an unlicensed GSM network. However, the use of UMA typically requires UMA features on both the wireless device and the network infrastructure.

Thus, there is a continuing need for better ways for a wireless device to achieve a seamless handover between networks.

### SUMMARY

In an embodiment of the invention, a technique to transfer a first telephony session between a first telephony device and a second telephony device from being conducted through a first network interface of the first telephony device to being conducted through a second network interface of the first telephony device includes the following. A second telephony session between the first network interface and the second network interface is initiated, and subsequently a media termination point of the first telephony session is changed from the first network interface to the second network interface. The technique further includes changing a media termination point of the second telephony session from the first network interface to a location associated with the second telephony device.

In another embodiment of the invention, a wireless device includes a first network interface to connect the wireless device to a first network and a second network interface to connect the wireless device to a second network. The wireless device includes a controller to transfer a first telephony session between the wireless device and a telephony device from being conducted through the first network interface to being conducted through the second network. The controller is adapted to initiate a second telephony session between the first network interface and the second network interface and change a media termination point of the first telephony session from the first network interface to the second network interface. The controller is further adapted to change a media termination point of the second telephony session from the first network interface to a location that is associated with the second telephony device.

In another embodiment of the invention, a technique to transfer a telephony session between a first telephony device and a second telephony device from being conducted through a first network interface of the first telephony device to being conducted through a second network interface of the first telephony device includes the following. The technique includes using the second network interface of the telephony device to change a media termination point of the telephony session from the first network interface to the second network interface.

In yet another embodiment of the invention, a wireless device includes a first network interface and a second network interface. The first network interface connects the wireless device to a first network, and the second network interface connects the wireless device to a second network. The wireless device includes a controller to transfer a telephony session between the wireless device and a telephony device from being conducted through a first network interface to being conducted through the second network interface by changing a media termination point of the telephony session from the first network interface to the second network interface.

Advantages and other features of the invention will become apparent from the following drawing, description and claims.

### BRIEF DESCRIPTION OF THE DRAWING

FIG. 1 is a schematic diagram of a telephony system illustrating signaling to and from a wireless device according to embodiments of the invention.

FIG. 2 is a schematic diagram of a telephony system illustrating media passes used by a wireless device according to embodiments of the invention.

FIG. 3 is a schematic diagram of a telephony system in accordance with embodiments of the invention.

FIG. 4 is a signal flow diagram illustrating handover of a VoIP call from a WiFi network to a cellular network according to embodiments of the invention.

FIG. 5 is a signal flow diagram illustrating a VoIP call over a cellular network according to embodiments of the invention.

FIG. 6 is a signal flow diagram illustrating handover of a VoIP call from a cellular network to a WiFi network according to embodiments of the invention.

FIG. 7 is a signal flow diagram illustrating handovers of a VoIP call between WiFi and cellular networks according to alternative embodiments of the invention.

### DETAILED DESCRIPTION

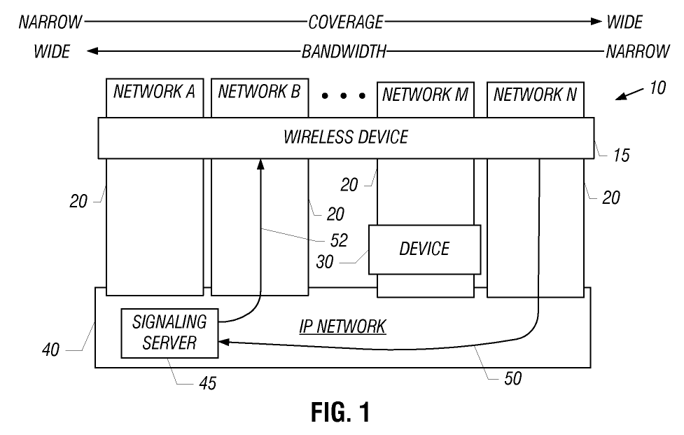

FIG. 1 illustrates a telephony system 10 in accordance with embodiments of the invention. The telephony system 10 includes a wireless device 15 (a mobile telephone, a personal digital assistant (PDA), a wireless access card on a mobile computer, etc.) that has multiple network interfaces, which permit access to various cellular and short range wireless networks 20 (specifically labeled as networks A, B . . . M and N in FIG. 1). Each network 20 has different advantages pertaining to the coverage of the network 20 and the available bandwidth. As illustrated in FIG. 1, there is a tradeoff between coverage and bandwidth, Therefore, in general, a relatively wide coverage network 20 has a relatively narrow bandwidth, and a relatively narrow coverage network has a relatively large bandwidth. As a more specific example, network N (a cellular network, for example) has a relatively wide coverage and a narrow bandwidth, as compared to network A (a short range wireless network, such as a WiFi network, for example), which has a relatively small coverage area and a relatively large bandwidth.

The wireless device 15 may be used for purposes of conducting a voice over Internet Protocol (VoIP) call, which involves a signaling session and a media session. A signaling server 45 (of an IP network 40) manages the signaling session status, and the signaling server 45 maintains location information for every device that belongs to the server 45.

The wireless device 15 drives signaling packets during the signaling session. When the wireless device 15 associates with multiple networks, the most appropriate network 20 is chosen for the signaling session. It is noted that the wireless device 15 may be assigned to a wide coverage area network (such as the network N) to be reachable from anywhere, or the wireless device 15 may register with every network 20. In the latter scenario, even if some of the networks 20 are out of area, the wireless device 15 may be reachable through the covered networks 20.

For security key exchanges, several different techniques may be used. For example, the wireless device 15 may use a separate path 50 for outgoing messages than a homeward path 52 that is used for incoming messages. Such a technique for exchanging security keys diminishes the risk of a man-in-the-middle attack or malicious packet monitoring.

FIG. 1 also depicts another device 30, which for purposes of this example communicates with the wireless device 15. It is noted that the device 30 may be a mobile wireless device, a landline telephone, a dedicated IP-based telephone, etc. By negotiation through signals, the devices 15 and 30 may begin media communications with each other. The wireless device 15 may select the proper network 20 for the media stream. If the wireless device 15 is to communicate a time sensitive stream, such as a voice stream, then the wireless device 15 may select network A, which has the highest bandwidth.

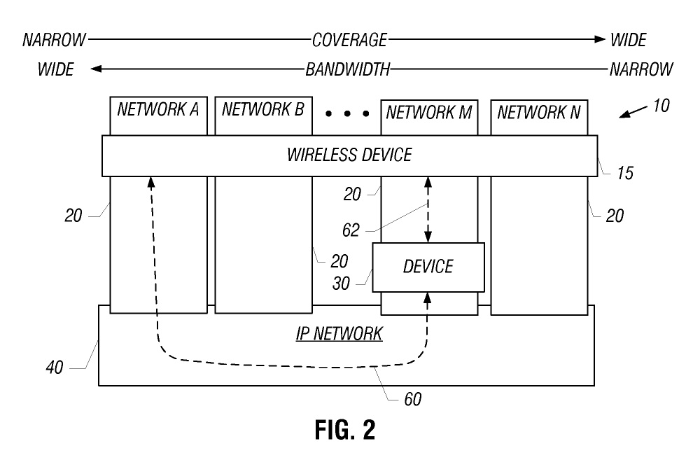

Alternatively, the wireless device 15 may select the shortest path to the device 30. Referring to FIG. 2, for example, the wireless device 15 may choose the shortest path to the device 30, which for this example is through network M. If, however, the wireless device 15 requires the widest bandwidth, the wireless device 15 may choose path 60, which uses network A. To work under a high packet loss condition, the wireless device 15 may use both paths 60 and 62 or may use three or more paths. Thus, many variations are contemplated and are within the scope of the appended claims.

In accordance with embodiments of the invention described herein, the wireless device 15 drives the media streams for handover, which occurs, as described in more detail below, when the wireless device 15 transfers a VoIP call between networks 20. As further described below, the signaling messages involved with the handover are communicated through a stable connection. Therefore, media re-negotiation is performed over the stable network, which is independent from the media stream passes. As described in more detail below, if the wireless device 15 detects that its current network (such as a WiFi network connection, for example) that is being used in the current media session is approaching an out-of-range condition, the wireless device 15 changes the routing of the media session so that the media session may continue uninterrupted through another network connection.

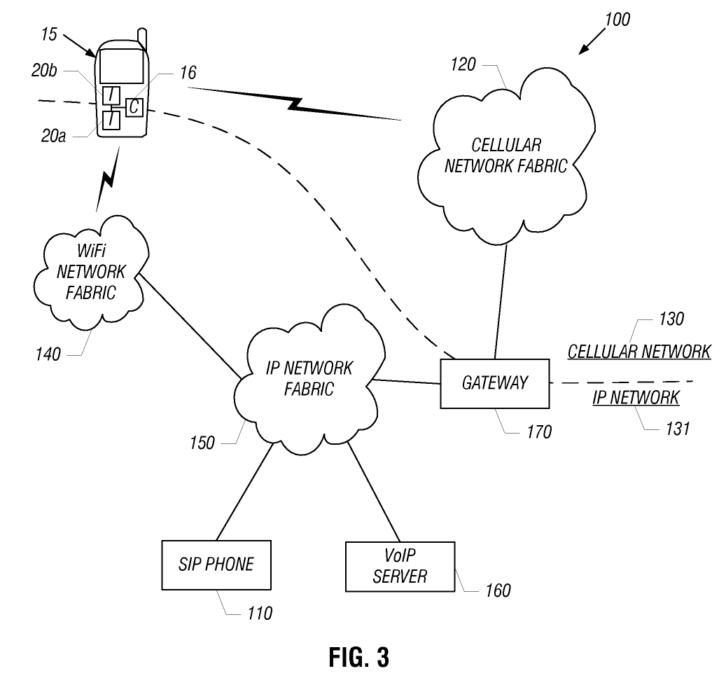

FIG. 3 depicts an exemplary telephony system 100 in accordance with some embodiments of the invention. As shown in FIG. 3, the telephony system 100 includes a cellular network 130 (a Global System for Mobile Communications (GSM) network, for example) and an Internet Protocol (IP) network 131. The cellular network 130 includes cellular network fabric 120 and may be selected by the wireless device 15 for purposes of signaling and/or media communication by the wireless device 15. The wireless device's communication over the cellular network 130 may involve the use of a voice channel to communicate circuit switched data, such as voice data, as well as the use of a data channel to communicate data with the IP network 131 via a packet switched data service (a General Packet Radio Service (GPRS), for example).

The IP network 131 for this example includes a short range wireless network, such as WiFi, and as such, the IP network 131 includes WiFi network fabric 140. It is noted that the IP network 131 may include one or more other short range networks (a WiMax network or a Bluetooth network, as non-limiting examples) that may alternatively be used by the wireless device 15 to connect to the IP network 131, in accordance with other embodiments of the invention. For purposes of simplifying the following discussion, it is assumed that the short range wireless network is a WiFi network, with it being understood that other short range wireless networks may be used in place of the WiFi network in accordance with other embodiments of the invention. Additionally, for the examples described herein, the wireless device 15 conducts a VoIP call with an IP telephony device, such as a Session Initial Protocol (SIP) telephone 110 (called the “SIP phone 110” herein). Among its other features, the IP network 131 includes a VoIP server 160 and a gateway 170. The gateway 170 establishes communication between the packet switched IP network 131 and circuit switched communications over the cellular network 130.

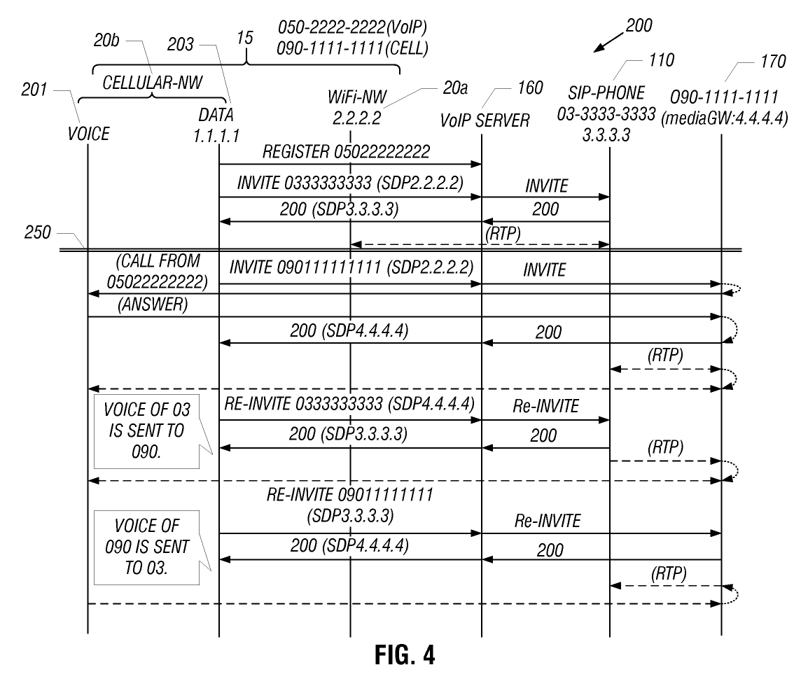

In accordance with embodiments of the invention described herein, the wireless device 15 includes multiple network interfaces, such as two exemplary network interfaces 20a and 20b that are depicted in FIG. 3. Referring to FIG. 3, for this example, the network interface 20a is a WiFi network interface that may be used by the wireless device 15, as further described below, for such purposes of communicating VoIP media with the IP network 131. The network interface 20b is a cellular interface that establishes communication with the cellular network 130. Thus, through the network interface 20b, the wireless device 15 may communicate through a circuit switched data voice channel and also through a packet switched data channel (via a GPRS data service, for example). The wireless device 15 also includes a controller 16 that controls the network interfaces 20a and 20b as described in FIGS. 4-6 below for purposes of conducting VoIP calls and for purposes of controlling handovers of VoIP calls between the WiFi and cellular networks.

FIG. 4 is a signal flow diagram 200, which illustrates a handover technique employed by the wireless device 15 to handover a VoIP call from being conducted through its WiFi connection to being conducted through its cellular network connection using only features on the wireless device 15. Thus, the handover technique that is described herein does not require any special server features or implementation, in accordance with some embodiments of the invention. Referring to FIG. 4, for the following example, the wireless device 15 has a VoIP number of “050-2222-2222” and a cellular number of “090-1111-1111.” Through its cellular connection, the wireless device 15 may communicate packet switched data through a data channel 203 and communicate circuit switched data through a voice channel 201. For communication with devices of the IP network 131 using the data channel 203, the wireless device 15 has an IP location of “1.1.1.1.” For the examples described herein, the wireless device 15 transmits signaling messages through the data channel 203. Also for the examples described herein, the WiFi network interface 20a of the wireless device 15 has an IP location of “2.2.2.2.”

For the following example, the wireless device 15 first places a VoIP call to the SIP phone 110 using the WiFi network, and then, the wireless device 15 initiates a handover, which transfers the call from being conducted through the WiFi network to being conducted through the cellular network. To place the VoIP call, the wireless device 15 first uses the data channel 203 to register the VoIP phone number of the wireless device 15 with the VoIP server 160 (see also FIG. 3). Next, the wireless device 15 uses SIP protocol over the data channel 203 in a signaling session to establish an upcoming media session with the SIP phone 110, which occurs through the WiFi network. For this example, the SIP phone 110 has a telephone number of “03-3333-3333” and an IP location of “3.3.3.3”.

More specifically, to set up the media session, the wireless device 15, using the data channel 203, sends an SIP invitation to the SIP phone 110. When the SIP phone 110 accepts the call (as indicated by the reply “200”), the wireless device 15 and the SIP phone 110 negotiate various session parameters, such as the medium, the transportation encoding, etc. For this example, real time transport protocol (RTP) is used, and the media session is routed through the WiFi network. Thus, as the end of the negotiation, an RTP media session is established between the SIP phone 110 and the WiFi interface 20a of the wireless device 15. Communication in this media session lasts until the session is terminated or the wireless device 15 travels to a location that is near the outer limit of the range of the WiFi network. The controller 16 (see also FIG. 3) detects when the latter condition occurs and controls signaling through the wireless device's network interfaces to cause a handover of the media session from occurring over the WiFi network to occurring over the cellular network.

The point at which the handover begins to occur is indicated by the double horizontal line 250 in FIG. 4. The wireless device 15 begins the handover by signaling through the data channel 203 to initiate a media session between the wireless device's WiFi and cellular network interfaces. More specifically, using the data channel 203, the wireless device 15 calls the cellular phone number (090-1111-1111) of the wireless device 15 and invites the cellular interface 20b to a media session with the WiFi interface 20a via the voice channel 201. After acceptance and negotiation of the parameters of the session, an RTP session is established between the WiFi interface 20a and the voice channel 201. Therefore, at this point, a first media session is established between the SIP phone 110 and the wireless device's WiFi network interface 20a, and a second media session is established between the wireless device's cellular 20b and WiFi 20a network interfaces.

Next, the wireless device 15 undergoes steps to route all communication with the SIP phone 110 through the wireless device's cellular network interface. More specifically, by the use of a SIP re-invite request that is communicated over the data channel 203, the wireless device 15 changes the media termination point of the first media session from the wireless device's WiFi interface 20a to the cellular interface 20b (and more specifically, to the voice channel 201). This reconfiguration creates a path for voice data to be transmitted from the SIP phone 110 to the wireless device 15. Next, through another SIP re-invite request, the wireless device 15 changes the media termination point of the second media session from the WiFi interface 20a to the SIP phone 110. Therefore, at this point the media is communicated entirely over the cellular network between the cellular interface of the wireless device 15 and the SIP phone 110: the voice data from the SIP phone 110 is transmitted in the modified media session to the cellular interface 20b; and the voice data from the wireless device 15 is transmitted via the cellular interface 20b in the second modified media session to the SIP phone 110.

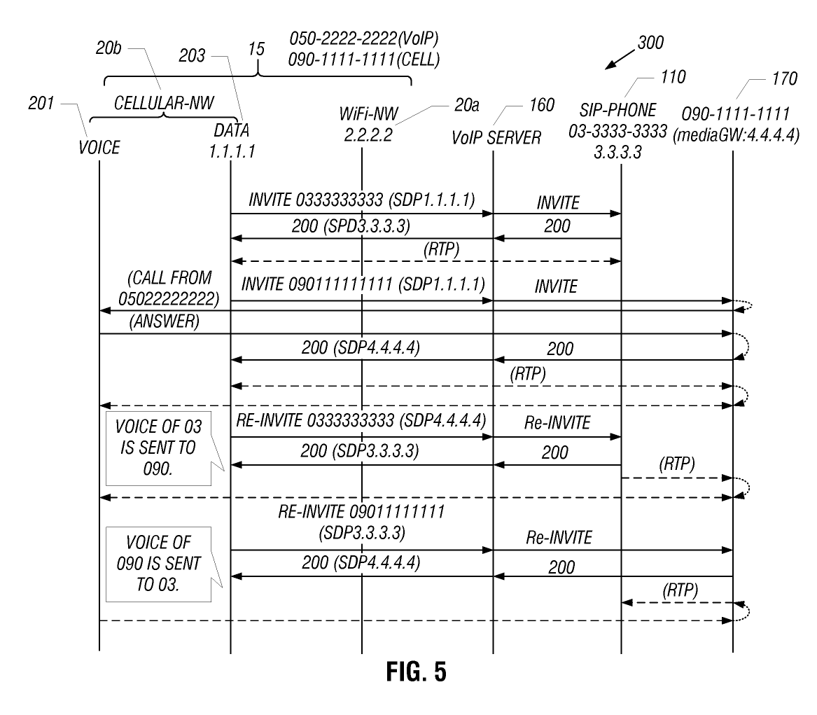

FIG. 5 depicts a signal flow 300 for the scenario in which the wireless device 15 is initially out of the coverage area of the WiFi network, and a VoIP call is initiated and conducted using the cellular interface 20b of the wireless device 15. Referring to FIG. 5, more specifically, the signal flow 300 depicts the initial setup of the VoIP call by the wireless device 15. Through the data channel 203, the wireless device 15 initiates a media session with the SIP phone 110, with the media termination point being the wireless device's data channel location 1.1.1.1. It is noted that the data channel 203 may have a relatively limited bandwidth. Therefore, in accordance with embodiments of the invention, the wireless device 15 creates ingoing and outgoing paths for the VoIP call through the cellular voice channel 201. More specifically, in accordance with embodiments of the invention, the wireless device 15, through the data channel 203, initiates a second media session between the data 203 and voice 201 channels. Next, the wireless device 15 takes steps to communicate the voice data from the SIP phone 110 through the first media session and communicate the voice data from the wireless device through the second media session.

More specifically, through the SIP re-invite request, the wireless device 15 changes the media termination point for the media session with the SIP phone 110 to the location of the voice channel 201. Thus, this media session is changed so that the voice from the SIP phone 110 is communicated to the voice channel 201. Through another SIP re-invite request, the wireless device 15 changes the media termination point for the session between the voice channel 201 and the data channel 203 to the location 3.3.3.3 of the SIP phone 110. Thus, due to this change, the voice from the wireless device 15 is communicated to the SIP phone 110.

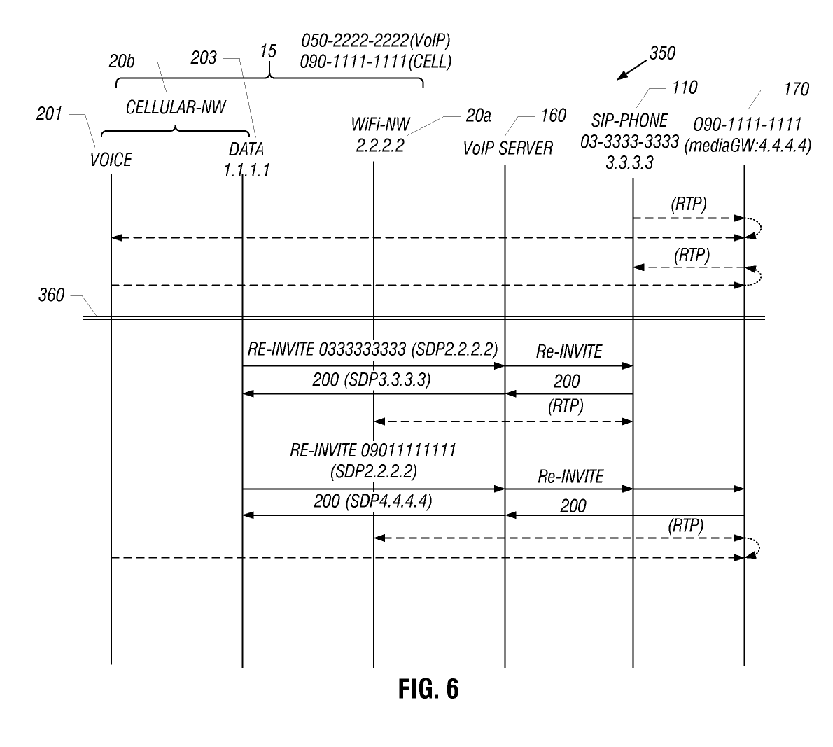

FIG. 6 illustrates a signal flow 350, which is a continuation of the signal flow 300 (FIG. 5) and is used by the wireless device 15 for purpose of causing a handover of the communication from occurring through the wireless device's cellular network interface to occurring through the wireless device's WiFi network interface when the wireless device 15 comes within range of the WiFi network. The change occurs at the double horizontal line 360 shown in FIG. 6. As depicted in FIG. 6, the handover involves the changing of the media termination points of the ongoing sessions over the cellular network. More specifically, using the SIP re-invite command, the wireless device 15 changes the media termination point for the media session in which voice data is communicated from the SIP phone 110 to the WiFi interface 20a. Thus, at this point, all voice data may be communicated between the SIP phone 110 and wireless device 15 over the WiFi network. Through another SIP re-invite request, the wireless device 15 changes the media termination point for the other media session from the SIP phone 110 to the WiFi network interface 20a, which aids in any subsequent handover to the cellular network.

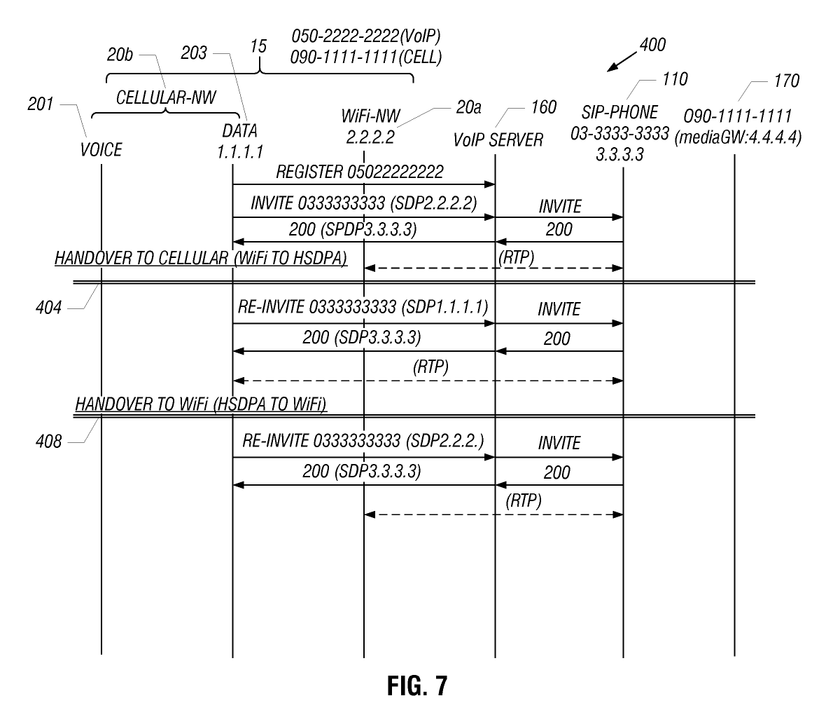

In the above discussion, the cellular data network is considered to have a relatively low bandwidth. However, in accordance with other embodiments of the invention, the cellular data network may have a relatively large bandwidth. As examples, in accordance with other embodiments of the invention, the wireless devices that are described herein may communicate with relatively high bandwidth cellular data networks, such as a High-Speed Downlink Packet Access (HSDPA) network or a Third Generation Partnership Project (3GPP) Long Term Evolution (LTE) network. For these embodiments of the invention, the wireless device may have a cellular network interface 20b that retains the cellular data network for signaling packets and also uses the cellular data network for purposes of media communications. More specifically, FIG. 7 depicts a signal flow 400, which illustrates a handover from a WiFi connection to a cellular connection and a handover from a cellular connection to a WiFi connection, in accordance with some embodiments of the invention.

More specifically, referring to FIG. 7, as described above, a wireless device 15 uses the WiFi connection established through the WiFi network interface 20a for purposes of conducting a VoIP call. When the WiFi network, however, is about to become out of range, the controller of the wireless device 15 begins a handover, which occurs below a double horizontal line 404 in FIG. 7. In this handover, the controller of the wireless device 15 uses the data channel 203 to change the media termination point via a SIP re-invite command. Thus, as shown in FIG. 7, by signaling through the data channel 203, the wireless device 15 changes the media termination point from the WiFi network interface 20a to the data channel 203 of the cellular network interface 20b (an HSDPA cellular interface, for example). Following this re-invitation, media communication occurs through the cellular data channel 203.

FIG. 7 also illustrates the handover from the cellular interface 20b to the WiFi interface 20a, which occurs below horizontal line 408. This handover also involves a SIP re-invitation command, which changes a media termination point from the cellular network interface 20b to the WiFi network interface 20a.

Other embodiments are within the scope of the appended claims. For example, although embodiments of the invention have been described herein, which use a relatively narrow bandwidth short range network, such as a WiFi, Bluetooth or WiMax network, other short range networks that have relatively high bandwidths may be used in accordance with other embodiments of the invention. Thus, in accordance with other embodiments of the invention, the wireless devices that are described herein may include corresponding short range network interfaces, such as a Personal Handy-phone System (PHS) interface, an Infrared Data Association (IrDA) interface, etc. Thus, many variations are contemplated and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method to transfer a first telephony session between a first telephony device and a second telephony device from being conducted through a first network interface of the first telephony device to being conducted through a second network interface of the first telephony device, the method comprising:
initiating a second telephony session between the first network interface and the second network interface;
changing a media termination point of the first telephony session from the first network interface to the second network interface; and
changing a media termination point of the second telephony session from the first network interface to a location associated with the second telephony device.

2. The method of claim 1, wherein the first network interface comprises a short range wireless network, the method further comprising:
performing the act of initiating the second telephony session in response to a determination that the first network interface is almost out of range of the short range wireless network.

3. The method of claim 2, wherein the short range wireless network comprises a network selected from the following: a WiFi network, a Bluetooth network, a WiMax network, a PHS network and an IrDA network.

4. The method of claim 1, wherein the act of initiating the second telephony session between the first network interface and the second network interface comprises establishing a media session between a short range wireless interface of the first telephony device and a cellular interface of the first telephony device.

5. The method of claim 1, wherein the act of changing the media termination point of the first telephony session from the first network interface to the second network interface comprises changing the media termination point of the first telephony session from a short range wireless network interface of the first telephony device to a cellular network interface of the first telephony device.

6. The method of claim 1, wherein the act of changing the media termination point of the second telephony session from the first network interface to a location associated with the second telephony device comprises changing the media termination point of the second telephony session from a short range wireless interface of the first telephony device to the location associated with the second telephony device.

7. The method of claim 1, wherein the first telephony device comprises a wireless telephony device.

8. The method of claim 1, further comprising:
transferring the first telephony session from being conducted through the second network interface of the first telephony device to being connected through the first network interface of the first telephony device, comprising:
changing a media termination point of the first telephony session from the second network interface to the first network interface.

9. A wireless device comprising:
a first network interface to connect the wireless device to a first network;
a second network interface to connect the wireless device to a second network; and
a controller to transfer a first telephony session between the wireless device and a telephony device from being conducted through the first network interface to being conducted through the second network interface, the controller adapted to initiate a second telephony session between the first network interface and the second network interface, change a media termination point of the first telephony session from the first network interface to the second network interface and change a media termination point of the second telephony session from the first network interface to a location associated with the telephony device.

10. The wireless device of claim 9, wherein the first network interface comprises a short range wireless network, the controller adapted to:
transfer the first telephony session in response to a determination that the first network interface is almost out of range of a short range wireless network.

11. The wireless device of claim 10, wherein the short range wireless network comprises a network selected from the following: a WiFi network, a Bluetooth network, a WiMax network, a PHS network and an IrDA network.

12. The wireless device of claim 9, wherein the first network interface comprises a short range wireless network and the second network interface comprises a cellular interface.

13. The wireless device of claim 9, wherein the wireless device comprises a mobile telephone.

14. The wireless device of claim 10, wherein the controller is adapted to transfer the first telephony session without using any handover feature of a server in communication with the wireless device.

15. The wireless device of claim 9, wherein the controller is further adapted to:
transfer the first telephony session from being conducted through the second network interface to being connected through the first network interface by changing a media termination point of the first telephony session from the second network interface to the first network interface.

16. The wireless device of claim 15, wherein the controller is further adapted to transfer the first telephony session in response to a determination that the first network interface is within range of a short range wireless network.

17. A method to transfer a telephony session between a first telephony device and a second telephony device from being conducted through a first network interface of the first telephony device to being conducted through a second network interface of the first telephony device, the method comprising:
using the second network interface of the telephony device to change a media termination point of the telephony session from the first network interface to the second network interface.

18. The method of claim 17, wherein the act of using comprises signaling through a cellular interface of the first telephony device to change the media termination point of the telephony session from the first network interface to the cellular interface.

19. The method of claim 17, wherein the first network interface comprises a short range wireless network, the method further comprising:
changing the media termination point of the telephony session in response to a determination that the first network interface is almost out of range of the short range wireless network.

20. A wireless device comprising:
a first network interface to connect the wireless device to a first network;
a second network interface to connect the wireless device to a second network; and
a controller to transfer a telephony session between the wireless device and a telephony device from being conducted through a first network interface to being conducted through the second network interface by changing a media termination point of the telephony session from the first network interface to the second network interface.

21. The wireless device of claim 20, wherein the first network comprises a cellular network and the second network comprises a short range wireless network.

22. The wireless device of claim 20, wherein the controller is further adapted to transfer the first telephony session between the wireless device and a telephony device from being conducted through the second network interface to being conducted through the first network interface by changing a media termination point of the telephony session from the second network interface to the first network interface.
